(19) United States
(12) Patent Application Publication
(10) Pub. No.: US 2012/0091376 A1
(43) Pub. Date: Apr. 19, 2012

(54) ACTUATOR FOR CONTROLLING A FLUID FLOW

(75) Inventors: JOERG KIESBAUER, EPPERTSHAUSEN (DE); THOMAS KARTE, BRUCHKOEBEL (DE); RUDOLF LAESSLER, MAINTAL (DE); KLAUS HOERSCHKEN, VILLMAR (DE)

(73) Assignee: SAMSON AG, FRANKFURT AM MAIN (DE)

(21) Appl. No.: 13/246,856

(22) Filed: Sep. 27, 2011

(30) Foreign Application Priority Data
Sep. 30, 2010 (DE) 102010037898.4-12

(51) Int. Cl. F16K 31/02

(52) U.S. Cl. 251/129.01

(57) ABSTRACT

The invention relates to an actuator (10) for controlling a fluid flow comprising a basic housing (12a) having an inlet (14) and an outlet (16), a valve seat (18) provided in the basic housing (12a) between said inlet and said outlet (14,16), a valve body (20) that can be operatively connected to the valve seat (18), a valve rod (22) for actuating said valve body (20) as well as means for actuating the valve rod (22) The invention is characterized in that an additional housing (12b) is mounted on said basic housing (12a) in a fluid tight manner and the means for actuating the valve rod is disposed within the housing(12) formed by the basic and additional housings (12a, 12b).

This application claims the priority of and benefit to German patent application number: 10 2010 037 897.6-12, filed on Sep. 30, 2010. German patent application number 10 2010 037 897.6-12, filed on Sep. 30, 2010, is incorporated herein by reference hereto the same as if rewritten herein verbatim.

The invention relates to an actuator for controlling a fluid flow,

The process industry uses actuators for controlling fluid flows which are normally not to enter the surrounding atmosphere. As far as design is concerned, the so-called “dynamic seals” should above all be noted here. A dynamic seal is used for sealing passages in a valve housing for example through which translational or rotational movements are introduced into the valve housing via a shaft. The shaft is used to move the valve body and varying the position of the valve body will result in the respective desired restriction effect. As dynamic seals are subject to wear and tear and other mechanisms, this may result in process fluid leaking into the surrounding atmosphere.

Actuators of this kind are well known in the prior art. Merely by way of example, reference is made to document DE 10 2006 061 017 A1.

It is the object of the invention to further improve an actuator for controlling a fluid flow so as to reduce the danger of leakage, and thus of process fluid being released into the surrounding atmosphere, and to avoid the aforementioned shortcomings.

As is generally known, the actuator for controlling a fluid flow comprises a basic housing having an inlet and an outlet. Mounted between the inlet and the outlet in the basic housing is a valve seat. Furthermore, the actuator comprises a valve body that can be operatively connected to the valve seat as well as a valve rod for actuating said valve body and means for actuating said valve rod.

According to the invention, an additional housing is mounted on said basic housing in a fluid tight manner and the means for actuating the valve rod is mounted within the housing formed by the basic and additional housings, with the housing—with the exception of the inlet and outlet as well as a passage for power supply of the means for actuating the valve rod—being formed as a completely encapsulated or sealed housing which is closed on all sides and has just one circumferential seal, and the valve rod is disposed without a passage, i.e. it completely extends inside the sealed housing.

The inventive design, in which the basic and additional housings are formed as a sealed housing, as well as the inventive passage-free mounting of the valve rod inside the closed housing advantageously provides an actuator which no longer has respective dynamic seals for sealing a valve rod that extends into the valve housing, thus eliminating the danger of leakage due to a damaged dynamic seal.

In this case the means for actuating the valve rod is preferably in the form of an electric motor which is operatively connected to the valve rod directly or via a transmission. The use of an electric motor as a means for actuating the valve rod turns out to be advantageous as it is highly reliable and exhibits low wear.

In a particularly advantageous embodiment of the actuator, the valve body is operatively connected to a drive disposed within the sealed housing, which drive is supplied with fluid flowing through said actuator. This turns out to be advantageous since it reduces the actuating force of the electric motor.

In one embodiment of the invention, the valve rod is completely guided within said housing, and the valve body is partly guided therein, with first and second chambers being formed between the valve body and the valve rod, which chambers are in fluid communication with each other via a through hole. In this design, the first chamber which is associated with the valve body is in fluid communication with the inlet via a through bore in the valve body, and the second chamber which is associated with the valve rod is in fluid communication with the outlet via a bore.

Furthermore, the valve rod is disposed and designed such that the through hole between the first and second chambers can be opened and closed by actuating the valve rod.

Preferably the valve body is spring-biased when guided within said housing. This ensures that the valve body will be returned in a simple manner.

In order to provide sufficient excess force and thus sufficient force action, the through hole is larger in diameter than the through bore.

According to yet another embodiment of the invention, the valve rod is spring-biased by a spring element when guided within the sealed housing.

As a drive, prior art fluid operated drives can basically also be used, both of the pneumatically and of the hydraulically actuated type. Considered advantageous is the use of a linear drive, and swivel drives can basically also be envisaged provided that their movement will be suitably converted. For controlling the drive, a prior art fluid actuated positioner with electric set point specification and mounted within the sealed housing may basically be conceived. One possible example of a positioner of this type is shown in DE 10 2005 024 686. Here the electric set point would be introduced by the electric passage in the housing that is dosed on all sides. The fluid flowing into the valve inlet would be used as a working fluid here. The exiting fluid would be suitably guided into the valve outlet. For controlling, the valve body position will be measured by a suitable sensor.

According to yet another embodiment of the invention which is considered particularly advantageous, a main valve is connected upstream of said actuator. In accordance with said actuator, the main valve comprises basic and additional housings, said basic housing having an inlet and an outlet as well as a valve seat provided between said inlet and said outlet, and said additional housing including a valve body that can be operatively connected to said valve seat as well as a balancing chamber having an outlet opening. Moreover, portions of said valve body are spring-biased when guided within the additional housing, and the balancing chamber is in fluid communication with the inlet of the main valve via a through bore in the valve body. The actuator which functions as a pilot stage has its inlet in fluid communication with the outlet opening of the main valve, and its outlet is in fluid communication with the outlet of the main valve. Furthermore, both the through bore in the valve body of the actuator and the through hole between the first and second chambers of the actuator are smaller in diameter than the through bore in the valve body of the main valve and the outlet opening of the balancing chamber of the main valve. As the pressure in the inlet of the actuator is equal to the input pressure of the main valve, the actuator has the same power as the main valve. Furthermore, as the flow is controlled by the main valve and the cross-sectional dimensions were suitably chosen, the actuating force which needs to be applied via the electric motor of the actuator will thus be clearly reduced in an advantageous way.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs. In the drawings

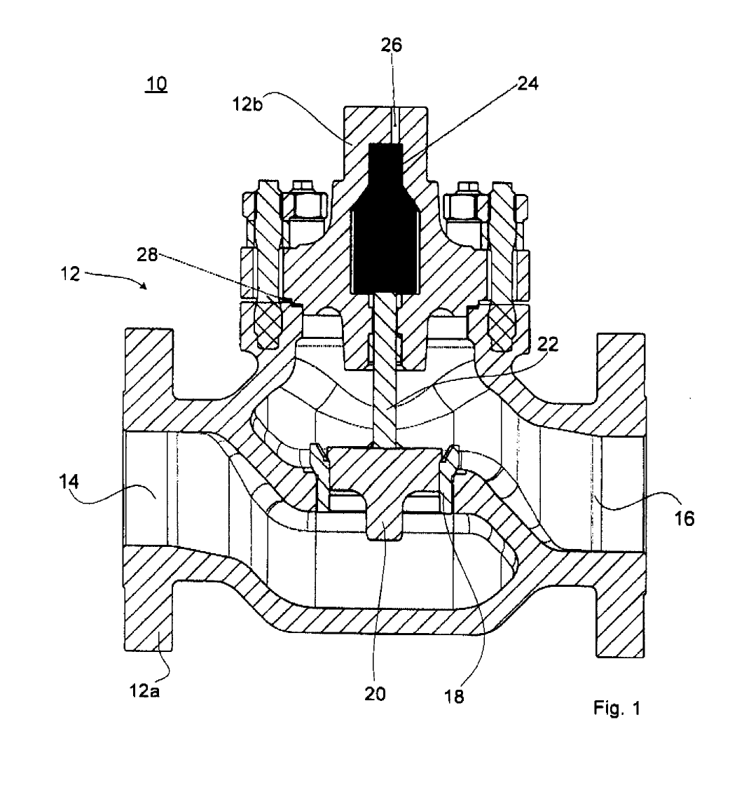

FIG. 1 is a view of a first embodiment of the actuator according to the invention;

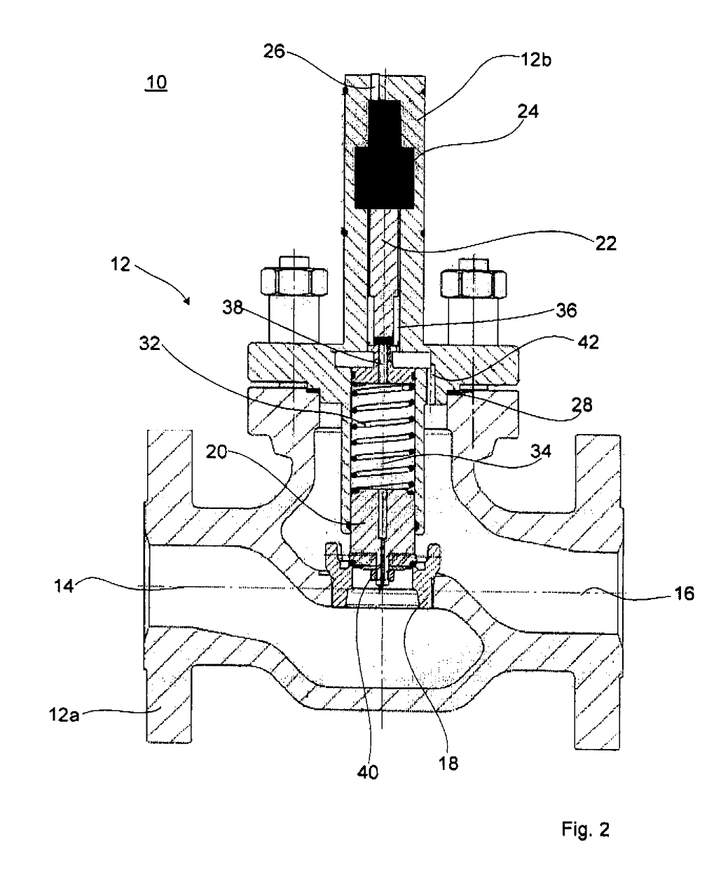

FIG. 2 is a view of a second embodiment of the actuator according to the invention;

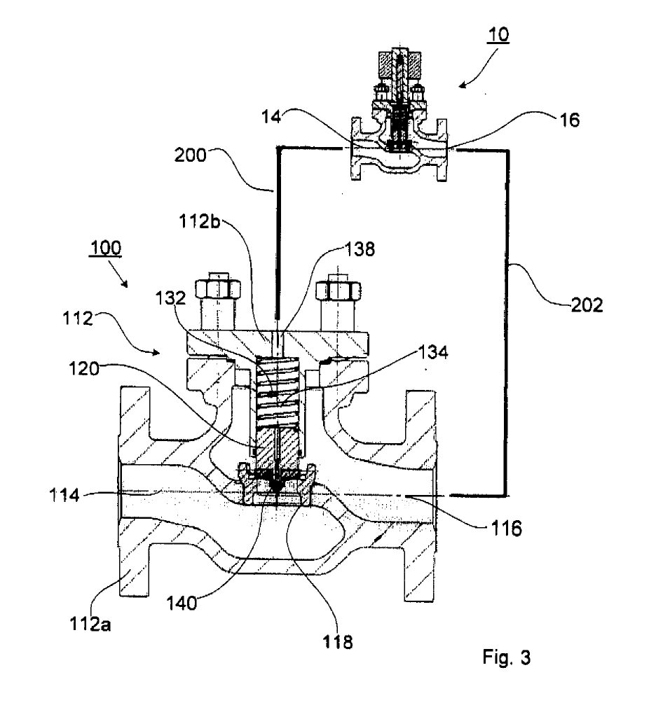

FIG. 3 illustrates the use of the actuator according to the invention as a pilot stage for a main valve.

In the description below and in the drawings, identical parts and components also bear the same reference numerals in order to avoid repetitions, as long as no further differentiation is required or expedient.

FIG. 1 is a more or less schematic view of an actuator marked 10 for controlling a fluid flowing through said actuator 10. The actuator 10 comprises a basic housing 12a having an inlet 14 and an outlet 16. Provided between said inlet 14 and said outlet 16 is a valve seat 18.

Moreover, the actuator 10 comprises a valve body 20 which is in turn connected to a valve rod 22. An electric motor 24 can be used to control a stroke movement of the valve rod 22, and thus also the flow between the valve body 20 and the valve seat 18.

The actuator 10 furthermore comprises an additional housing 12b. As can clearly be seen in FIG. 1, the additional housing 12b is mounted on the basic housing 12a in a fluid tight manner and in such a way that the basic and additional housings 12a, 12b—except for the inlet and the outlet 14, 16 and a passage 26 for the power supply of the electric motor 24—will form a completely sealed housing 12 which is closed on all sides and only includes one circumferential seal 28. As may further be seen in FIG. 1, the additional housing 12b is moreover designed such that—besides the electric motor 24—also the valve rod 22 is disposed without any passage, i.e. it is completely accommodated within the sealed housing 12.

In contrast to the first embodiment of the invention, the second embodiment illustrated in FIG. 2 has the additional housing 12b designed such that the valve rod 22 is completely guided within said additional housing 12b and the valve body 20 is partly guided within said additional housing 12b. In this case, the valve body 20 is spring-biased by a spring 32 as it is guided within said additional housing 12b.

Moreover, provided between said valve body 20 and said valve rod 22 are first and second chambers 34 and 36, respectively, which are in fluid communication with each other via a through hole 38. Whereas the first chamber 34 is in fluid communication with the inlet 14 via a through bore 40 provided in the valve body 20, the second chamber 36 is in fluid communication with the outlet 16 via a bore 42.

As may further be gathered from FIG. 2, the valve rod 22 is disposed and designed in such a way that the through hole 38 between the first and second chambers 34, 36 can be opened and closed by actuating said valve rod 22.

As will become obvious from the following consideration, this will diminish the force required for actuating the valve rod 22. For pressure relief, the fluid will be supplied to the first chamber 34 via the through bore 40 in the valve body 20 and thus to the rear of the valve body 20. Consequently, no forces will act on the valve body 20. In this state, the valve body 22 will be pressed into the valve seat 18 by the full force of the spring 32. Movement of the valve body 20 may now be accomplished by reducing the pressure acting on the top of the valve body 20. For this purpose, the through hole 38 between the first and second chambers 34, 36 will be opened by a movement of the valve rod 22. As a result, fluid may flow from the first chamber 34 via the through hole 38 to the second chamber 36 and from there to the outlet 16 via the bore 42. In this case, the ratio of the through hole 38 to the through bore 40 has been chosen such that the through hole 38 will allow a clearly larger flow therethrough so that—with the through hole 38 completely open—an almost complete depressurization above said valve body 20 may be accomplished.

As shown in FIG. 3, a main valve generally designated 100 is connected upstream of the actuator 10 according to the invention. To avoid repetitions as regards the structure of the actuator 10, reference is made to what has already been set out with respect to FIG. 2 above.

The main valve 100 comprises a basic housing 112a which has an inlet 114 as well as an outlet 116. Provided between said inlet 114 and said outlet 116 is a valve seat 118.

The main valve 100 furthermore comprises an additional housing 112b which—together with the basic housing 112a forms a housing 112 of the main valve 100.

In this case the additional housing 112b is formed such that portions of a valve body 120 operatively connected to the valve sear 118 are guided within said additional housing 112b and spring-biased by a spring 132. Moreover, the additional housing 112b includes a balancing chamber 134 having an outlet opening 138.

While the balancing chamber 134 is in fluid communication with the inlet 114 of the main valve 100 via a through bore 140 provided in the valve body 120, the outlet opening 138 is connected to the inlet 14 of the actuator 10 via a line 200 and the outlet 16 of the actuator 10 is connected to the outlet 116 of the main valve 100 via a line 202. In this case, the diameter of the through bore 40 in the valve body 20 of the actuator 10 is substantially smaller than the diameter of the through bore 140 in the valve body 120 of the main valve, and also the diameter of the outlet opening 138 in the housing 112b of the main valve 100 is substantially smaller than the through hole 38 between the first and second chambers 34, 36 of the actuator.

As the pressure in the inlet 16 of the actuator 10 is equal to the input pressure of the main valve 100, the actuator 10 has the same power as the main valve 100. Furthermore, as the flow is controlled by the main valve 100 and the cross-sections were suitably chosen, this clearly reduces the actuating force that needs to be exerted by means of the electric motor 24 of the actuator 10 in an advantageous manner.

### LIST OF REFERENCE SIGNS

10 actuator

12 housing

12a basic housing

12b additional housing

14 inlet

16 outlet

18 valve seat

20 valve body

22 valve rod

24 electric motor

26 passage

28 seal

32 spring

34 first chamber

36 second chamber

38 through hole between first and second actuator chambers

40 through hole in the valve body of said actuator

42 bore

100 main valve

112 housing

112a basic housing

112b additional housing

114 inlet

116 outlet

118 valve seat

120 valve body

132 spring

134 balancing chamber

138 outlet opening

140 through bore

200 line

201 line

1-9. (canceled)

10. An actuator (10) for controlling a fluid flow, comprising:
a housing (12), said housing includes a basic housing (12a) and an additional housing (12b);
said basic housing (12a) includes an inlet (14) and an outlet (16);
a valve seat (18), said valve seat resides between said inlet and said outlet (14,16) within said basic housing (12a);
a valve body (20), said valve body operatively connected to said valve seat (18);
a valve rod (22) for actuating said valve body (20);
means for actuating said valve. rod (22);
an additional housing (12b) mounted on said basic housing (12a) in a fluid tight manner;
said means for actuating said valve rod is mounted within said housing (12), said means for actuating said valve rod is formed by said basic and additional housings (12a, 12b);
said housing includes a passageway (26), said passageway permits supply of power to said means for actuating said valve rod;
said housing (12) is dosed on all sides, except for said inlet and outlet (14, 16) and except for a passage (26) for said supply of power to said means for actuating said valve rod, and is completely sealed;
said housing 12 includes one circumferential seal (28) between said basic housing (12a) and said additional housing (12b); and,
said valve rod (22) is completely disposed within said sealed housing (12).

11. The actuator (10) for controlling a fluid flow as claimed in claim 10, wherein said means for actuating said valve rod is in an electric motor (24).

12. The actuator (10) for controlling a fluid flow as claimed in claim 11 wherein said electric motor (24) is operatively connected to said valve rod (22) directly or via a transmission.

13. The actuator (10) for controlling a fluid flow as claimed in claim 10, further comprising a fluid-supplied drive within said sealed housing, and, wherein said valve body (20) is operatively connected to said fluid-supplied drive within said sealed housing.

14. The actuator (10) for controlling a fluid flow as claimed in claim 10, further comprising:
a positioner residing within said sealed housing (12), said positioner includes a set point for the position of said valve body (20);
said positioner extracting working fluid from said valve inlet;
said positioner determining said valve body (20) position and regulating said position of said valve body (20) according to said positional set point; and,
said set point is controlled through said passageway into said housing (12) that is closed on all sides,

15. The actuator (10) for controlling a fluid flow, as claimed in claim 10, further comprising:
said valve rod (22) is completely guided within said housing;
said valve body (20) is partly guided within said housing;
first and second chambers (34, 36) reside between said valve body (20) and said valve rod (22);
said first and second chambers (34, 36) are in fluid communication with each other via a through hole (38);
said first chamber (34) is adjacent valve body (20) and is in fluid communication with said inlet (14) of said basic housing (12a) via a through bore (40) in said valve body (20);
said second chamber (36) is adjacent said valve rod (22) and is in fluid communication with said outlet (16) via bore (42) in said additional housing;
said valve rod (22) is movable and opens and closes said through hole (38) communicating between said first and second chambers, allowing or prohibiting communication between said first and second chambers (34, 36).

16. The actuator (10) for controlling a fluid flow as claimed in claim 15 further comprising a spring element (32) and wherein said valve body (20) is guided within said housing under spring bias from a spring element (32).

17. The actuator (10) for controlling a fluid flow as claimed in claim 16, wherein said through hole (38) is larger in diameter than said through bore (40).

18. Use of an actuator (10), according to claim 13, for controlling a main valve (100), wherein:
said main valve (100) comprises basic and additional housings (112a, 112b);
said basic housing (112a) has an inlet and an outlet (114, 116) as well as a valve seat (118), said valve seat disposed between said inlet and said outlet (114, 116);
said additional housing (112b) includes a valve body (120) operatively connected to said valve seat (118), as well as a balancing chamber (134) with an outlet opening (138);
said the valve body (120) is partly guided within said additional housing (112b) under spring bias;
said balancing chamber (134) is in fluid communication with said inlet (114) of the main valve (100) via a through bore (140) in the valve body (1);
said outlet opening (138) of said balancing chamber (134) being in fluid communication with said inlet (14) of said actuator (10);
said outlet (16) of said actuator (10) being in fluid communication with said outlet (6) of said main valve (100);
said through bore (40) in said valve body (20) of said actuator (10) as well as said through hole (38) between said first and second chambers (34, 36) of said actuator (10) are smaller in diameter than said through bore (140) in said valve body (120) of said main valve (100) and said outlet opening (138) of said balancing chamber (134) of said main valve (100).
